(19) United States
(12) Patent Application Publication
(10) Pub. No.: US 2018/0253739 A1
(43) Pub. Date: Sep. 6, 2018

(54) Automated Endorsement Prompting

(71) Applicants: Subramaniam Ganapathy, Mountain View, CA (US); Adam Drew Bursey, San Jose, CA (US); Amay Nitin Champaneria, San Francisco, CA (US); Matthew Kulick, San Francisco, CA (US); David Yen, San Francisco, CA (US); Sagar Kamdar, Redwood City, CA (US)

(72) Inventors: Subramaniam Ganapathy, Mountain View, CA (US); Adam Drew Bursey, San Jose, CA (US); Amay Nitin Champaneria, San Francisco, CA (US); Matthew Kulick, San Francisco, CA (US); David Yen, San Francisco, CA (US); Sagar Kamdar, Redwood City, CA (US)

(73) Assignee: GOOGLE INC., Mountain View, CA (US)

(21) Appl. No.: 13/550,378

(22) Filed: Jul. 16, 2012

Related U.S. Application Data
(60) Provisional application No. 61/525,795, filed on Aug. 21, 2011.

(51) Int. Cl. G06Q 30/02

(52) U.S. Cl. CPC G06Q 30/02

(57) ABSTRACT

In one aspect, an automated endorsement prompt systems includes an endorsement prompt module comprising an endorsement signal module for retrieving an endorsement signal from an endorsement server; a search result module for retrieving search results from a search engine; a web history module for retrieving a web history for a user; and combiner logic for providing search results and an endorsement prompt. The combiner logic generates the endorsement prompt from the endorsement signal and the web history. A method for automatically generating endorsement prompts including the steps of: receiving a query from a user; obtaining additional information signals; obtaining a search result using the query; determining whether prompt behavior exists using the additional information; generating a prompt for an endorsement if the prompt behavior exists; and providing the search result and the prompt for presentation.

### CROSS REFERENCE TO RELATED APPLICATIONS

This application claims the benefit under 35 U.S.C. § 119(e) of U.S. Provisional Application No. 61/525,795, entitled “Automated Endorsement Prompting” filed on Aug. 21, 2011, the entire contents of which are incorporated herein by reference.

### BACKGROUND

The present disclosure relates to endorsing content. In particular, the present disclosure relates to automated endorsement prompting.

The popularity and use of the Internet, search engines web browsers, social networks and other types of electronic communication has grown in recent years. Search engines may customize data that is presented to the user based on information the search engine knows about user. Thus, two users inputting the same query may receive different search results or search results ordered differently.

In the context of social networks, users may be able to indicate whether they recommend or endorse a particular piece of content. Users may be able endorse a particular piece of content by activating a button or other mechanism for making a recommendation or endorsement of the content.

### SUMMARY

In one innovative aspect, an automated endorsement prompt system includes an endorsement prompt module. The endorsement prompt module comprises an endorsement signal module for retrieving an endorsement signal from an endorsement server; a search result module for retrieving search results from a search engine; a web history module for retrieving a web history for a user; and combiner logic for providing search results and an endorsement prompt, the combiner logic generating the endorsement prompt from the endorsement signal and the web history, the combiner logic coupled to the output of the endorsement signal module to receive the endorsement signal, the search result module to receive the search results, and the output of the web history module to receive the web history.

The present disclosure also includes a method for automatically generating endorsement prompts including the steps of: receiving a query from a user; obtaining additional information signals; obtaining a search result using the query; determining whether prompt behavior exists using the additional information; generating a prompt for an endorsement if the prompt behavior exists; and providing the search result and the prompt for presentation.

One or more of the implementations described can also include the following features: additional information signals that include user input signals from a client device, endorsement signals from an endorsement server, a web history for the user, social data from a social network, or an identity of the user; input signals from the client device that indicate a transition from a search result page to a first web page and a return to the search result page after a predetermined amount of time; a signal indicating that an endorsement prompt was presented to the user and rejected by the user; a web history indicating that user has viewed a web page a predetermined number of times; a prompt that includes an explanation why the prompt is being presented; a prompt that includes one or more identifiers of other users that have endorsed the result; an endorsement signal module retrieves a positive endorsement signal from the endorsement server and sends the positive endorsement signal to the combiner logic; a negative endorsement signal from the endorsement server and sends the negative endorsement signal to the combiner logic; the combiner logic generates the endorsement prompt in response to a hover over input signal; and a social data module for retrieving social information from a social network and wherein the social information is used by the combiner logic to generate the endorsement prompt.

Other aspects include corresponding systems, methods and apparatus, including computer program products.

The systems and methods disclose below are advantageous in a number of respects. First, they provide to a system and method for soliciting confirmations about preferences of users with minimal intrusion. Second, they present endorsement prompts in context where they are most understandable to the user. Third, in certain implementations they provide personalization of the endorsement prompts to the user.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a block diagram illustrating an example of an automated endorsement prompt system.

FIG. 2 is a block diagram illustrating an example of the automated endorsement prompt system.

FIG. 3 is a block diagram illustrating an example of the endorsement prompt module.

FIGS. 4A and 4B are flowcharts of examples of methods for providing an endorsement prompt.

FIGS. 5-9 are graphic representations of implementations of example user interfaces for presenting endorsement or sharing prompts.

### DETAILED DESCRIPTION

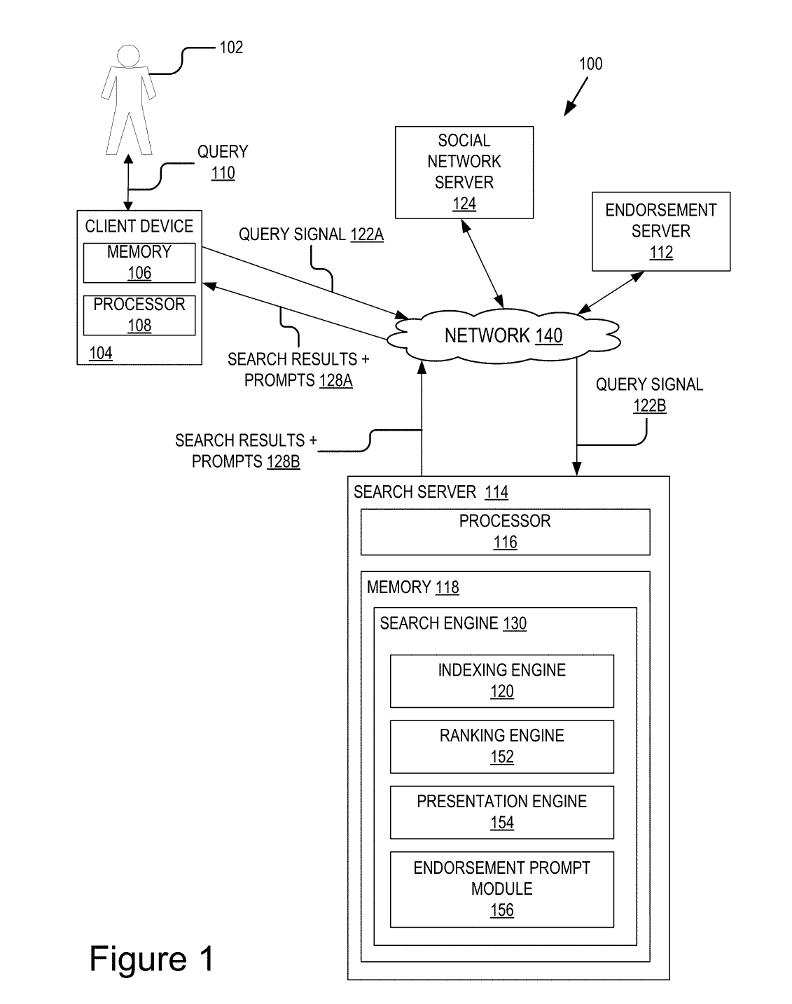

FIG. 1 illustrates an implementation of an automated endorsement prompt system 100. The automated endorsement prompt system 100 comprises a client device 104, a network 140, a search server 114, an endorsement server 112 and a social network server 124. The client device 104 is utilized by a user 102 to input a query 110 to retrieve information from the search server 114. The client device 104 is coupled for communication with the network 140 which in turn is coupled for communication with the search server 114, the endorsement server 112 and the social network server 124.

Although only a single user 102 and client device 104 are illustrated, any numbers of client devices 115 can be available to any number of users 102. Furthermore, while only one network 140 is coupled to the client device 104, the endorsement server 112, the search server 114, and the social network server 124 in practice any number of networks 140 can be connected to the system 100. Additionally, while only one endorsement server 112, search server 114, and social network server 124 is respectively shown, the system 100 could include one or more endorsement servers 112, search servers 114 and social network servers 124. Moreover, while the present disclosure is described below primarily in the context of prompting for endorsements when search results are presented, the present disclosure is applicable to any type of online communications where automated prompting of endorsement is applicable.

The client device 104 comprises a memory 106 and a processor 108. The client device 104, for example, may be a personal computer, a laptop computer, a tablet computer, a mobile phone (e.g., a smart phone) or any other computing device.

The memory 106 stores instructions and/or data that may be executed by the processor 108. The memory 106 is coupled to a bus for communication with the other components. The instructions and/or data may comprise code for performing any and/or all of the techniques described herein. The memory 106 may be a dynamic random access memory (DRAM) device, a static random access memory (SRAM) device, flash memory or some other memory device known in the art.

The processor 108 comprises an arithmetic logic unit, a microprocessor, a general purpose controller or some other processor array to perform computations and provide electronic display signals to a display device. The processor 108 is coupled to a bus for communication with the other components. Processor 108 processes data signals and may comprise various computing architectures including a complex instruction set computer (CISC) architecture, a reduced instruction set computer (RISC) architecture, or an architecture implementing a combination of instruction sets. Although only a single processor is shown in FIG. 1, multiple processors may be included. Other processors, operating systems, sensors, displays and physical configurations are possible.

The client device 104 is configured for communication with the network 140. In response to user input, the client device 104 generates and sends a search query, e.g., in the form of a query signal 122A, to the network 140. The network 140 receives and passes on the query signal 122B to the search server 114. The search server 114 processes the query signal 122B as will be described in more detail below to generate search results and one or more prompts. The search server 114 sends the search results and prompts 128B to the network 140 which in turn sends the search results and prompts 128A to the client device 104 for presentation to the user 102.

Although not shown, the client device 104 may include other endorsement prompt software or routines operable on the client device 104 for performing some or all of the operations required for generating the user interfaces described below, processing user input to generate one or more prompts, and generating signals to take action related to the one or more prompts. For example, the endorsement prompt software or routines may be a plug-in to a web browser 202, java script or other software or code that cooperates with the browser.

The network 140 can be wired or wireless, and may have any number of configurations, for example, a star configuration, token ring configuration or other configurations. Furthermore, the network 140 may comprise a local area network (LAN), a wide area network (WAN) (e.g., the Internet), and/or any other interconnected data path across which multiple devices may communicate. In some implementations, the network 140 may be a peer-to-peer network. The network 140 may also be coupled to or includes portions of a telecommunications network for sending data in a variety of different communication protocols. In some implementations, the network 140 includes Bluetooth communication networks or a cellular communications network for sending and receiving data for example via short messaging service (SMS), multimedia messaging service (MMS), hypertext transfer protocol (HTTP), direct data connection, wireless application protocol (WAP), email, etc.

The search server 114 comprises a processor 116 and a memory 118. The processor 116 is similar to the processor 108 described above; however, it may have increased computing capability. The memory 118 is similar to the memory 106 described above; however, it may be larger in size, have faster access time, and also include volatile and nonvolatile memory types.

In some implementations, the memory 118 stores a search engine 130 that includes an indexing engine 120, a ranking engine 152, a presentation engine 154 and an endorsement prompt module 156. The search engine 130 is operable on the processor 116 to receive the query signal 122 and in response return search results and prompts 128.

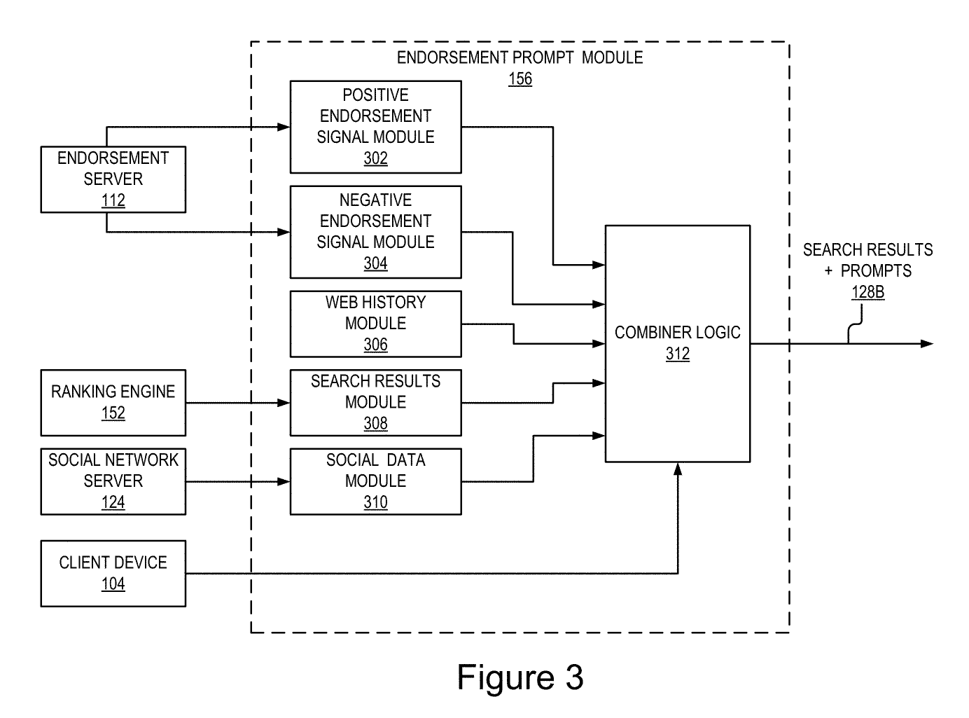

One or more of the search engine 130, the indexing engine 120, the ranking engine 152, the presentation engine 154 and the endorsement prompt module 156 are stored in the memory 118 and are accessible and executable by the processor 116. In some implementations, one or more of the search engine 130, the indexing engine 120, the ranking engine 152, the presentation engine 154 and the endorsement prompt module 156 store data that, when executed by the processor 116, causes these engines to perform the operations described below. In some implementations, one or more of the search engine 130, the indexing engine 120, the ranking engine 152, the presentation engine 154 and the endorsement prompt module 156 are instructions executable by the processor 116 to provide the functionality described below with reference to FIGS. 3-9.

The indexing engine 120 is software or routines for creating an index or indices for multiple sources of content. In some implementations, the indexing engine 120 indexes video data and web data. The indexing engine 120 collects, parses and stores data to facilitate information retrieval. The indexing engine 120 also processes search queries. The indexing engine 120 receives a search query and returns search results from the data sources that match the terms in the search query. The indexing engine 120 is coupled to receive a search query from the presentation engine 154.

The ranking engine 152 is software or routines for ranking search results based upon relevance to the search query. The ranking engine 152 is coupled to receive the search results from the indexing engine 120. The ranking engine 152 can reorder the search results based upon terms in the query as well as other factors about the user. In some implementations, the ranking engine 152 is coupled for communication with the endorsement prompt module 156 to modify the ranking of the search results based on input signals from the endorsement prompt module 156. In such an implementation, the modified search results or respective rankings are output from the ranking engine 152 to the presentation engine 154. In some implementations, the reordered results or rankings of the output by the ranking engine 152 are output to the endorsement prompt module 156, which further reorders the results and then provides them to the presentation engine 154.

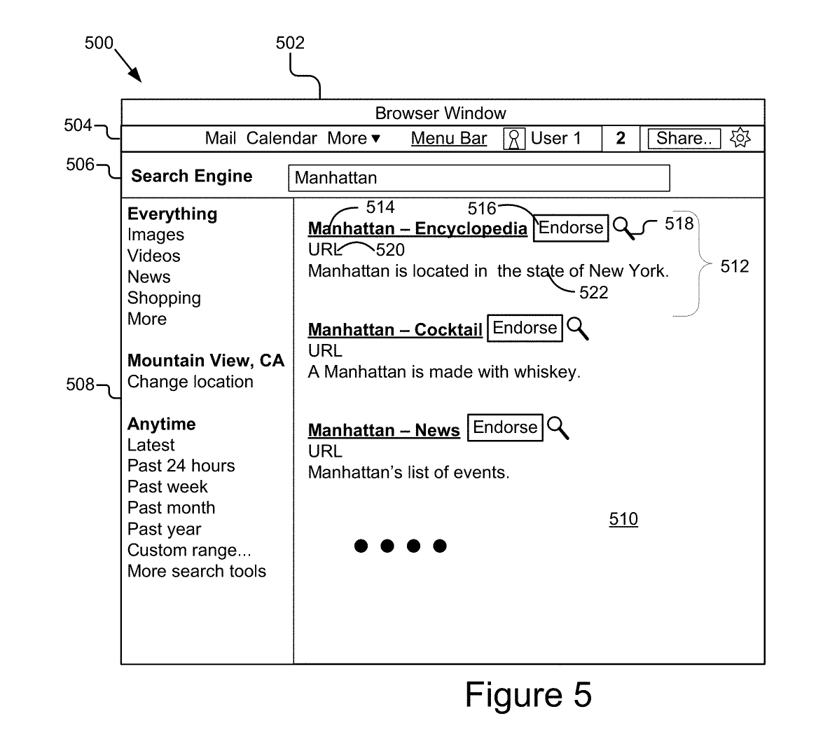

The presentation engine 154 is software or routines for receiving a query signal and sending the query signal to the indexing engine 120. The presentation engine 154 is coupled to the indexing engine 120 to provide the query signal. The presentation engine 154 also receives search results from the ranking engine 152. The presentation engine 154 formats and sends the search results via the network 140 to the client device 104. In some implementations, the presentation engine 154 also receives prompts in addition to or as part of the search results. The presentation engine 154 formats and sends these prompts for presentation on the client device 104. Some implementations of the formatting and presentation of these prompts are shown and described below with reference to FIGS. 5-9.

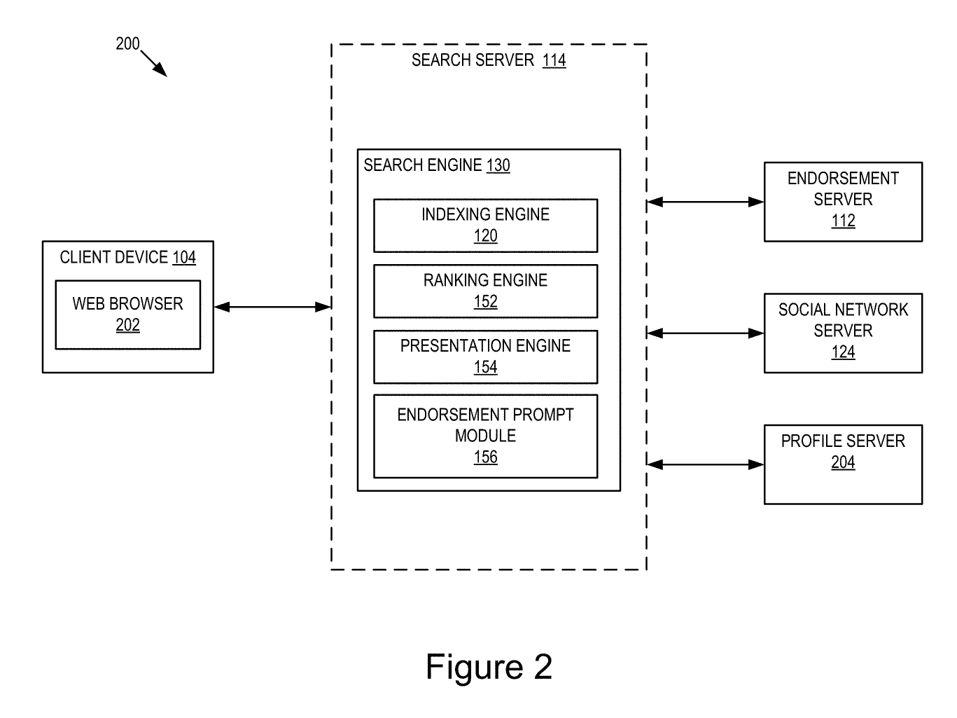

The endorsement prompt module 156 is software or routines for tracking the user interaction with web pages, generating prompts and presenting prompts. The endorsement prompt module 156 obtains information or additional information about a user's interaction with content. The content may be a search result from a search engine; a web page from a third party server; and information from a social network. In some implementations , the content may be a particular resource or identity, e.g., a domain or sub-domain of a network. The endorsement prompt module 156 is coupled to receive other types of information, for example, public information about a user social graph, public information about user interaction with the social network, user interaction with a multimedia content sharing site, or other system with which a user may interact, for example, micro-blogs, comments, votes (e.g., indicating approval of particular content), other indications of interest (e.g., that promote content for consumption by other users), playlists (e.g., for video or music content). In some implementations, users can be provided options to opt-in or opt-out of having this type of information being used. In these and other implementations, the endorsement prompt module 156 receives social information from the social network server 124 and endorsement information from the endorsement server 112. The endorsement prompt module 156 and its operation will be described in more detail below with reference to FIGS. 2-4. The present disclosure will be described below in the context of search results and endorsements; however, the principles and concepts of the disclosed technologies can be applied to other types of automated generation of prompts associate with content. In some implementations, the endorsement prompt module 156 modifies the ranked and formatted search results by adding the prompts and sends them to the client device 104. In some implementations, the endorsement prompt module 156 provides the prompts to the presentation engine 154 that combines them with the search results and sends them to the client device 104.

In some implementations, the social network server 124 is coupled to the network 140. The social network server 124 also includes a social network software/application. Although one social network server 124 is shown in detail, multiple social network servers 124 may be present. A social graph of the social network can be used to represent relationships/connections of users of the social network, e.g., friendships, family relationships, work relationships, common interests, etc. These features are provided by one or more social networking systems, for example those included in the system 100, including explicitly-defined relationships and relationships implied by social connections with other online users, where the relationships form a social graph. In some examples, the social graph can reflect a mapping of these users and how they are related. Furthermore, the social network server 124 and social network software/application are representative of a social network and that, in some implementations, there may be multiple social networks coupled to the network 140, each having its own server, application and social graph. For example, a first social network can be more directed to business networking, a second can be more directed to or centered on academics, a third can be more directed to local business, a fourth can be directed to dating and others of general interest or a specific focus. Furthermore, the social network server 124 may provide personalized streams of content including photos, posts, shares, and other information from a variety of sources including contacts of the user or other users in the social graph, colleagues, news sources, etc. The social network server 124 is coupled to provide social information to the endorsement prompt module 156.

The endorsement server 112 comprises a processor and a memory. The endorsement server 112 also includes software or routines operable on the server to implement the endorsement system. In some implementations, the endorsement server 112 is a system for tracking content and indicating users who have endorsed or recommended existing content. In some implementations, users can be provided options to opt-in or opt-out of having this type of information being used, collected and shared with others. The endorsements and data may also be anonymized before being provided to others. In some implementations, the endorsement or recommendation system implemented by the endorsement server 112 is applicable to information available on the World Wide Web, content created by users of the social network, or content available over the Internet, for example, videos. The endorsement server 112 is coupled to receive endorsements from the user, coupled to receive search results, and coupled to provide endorsement information to the endorsement prompt module 156. In some implementations, the endorsement server 112 includes the endorsement prompt module 156 that operates as will be described below to provide information to the presentation engine 154.

Referring now to FIG. 2, a second implementation for the automated endorsement prompt system 200 is described. As shown, the second implementation for the automated endorsement prompt system 200 comprises the client device 104, the search server 114, the endorsement server 112 and the social network server 124. These components have the same or similar functionality as has been described above with reference to FIG. 1, so that description will not be repeated here. FIG. 2 is provided to illustrate some implementations for automated endorsement prompt system 200. More specifically, FIG. 2 illustrates the communication paths between the client device 104, the search server 114, the endorsement server 112 and the social network server 124. In this implementation, the user 102 interacts with the web browser 202 operable on the client device 104. In some implementations, the user may log in with a user account to a profile server 204 so the identity of the user (and other preferences or information) is known to the search server 114. The client device 104 may send a query for content and results and links are provided by the search server 114. In addition to the search results, the endorsement prompt module 156 operable as part of the search engine 130 also provides automated prompt information. The endorsement prompt module 156 is coupled to the endorsement server 112 to receive endorsement information and the social network server 124 to receive social information.

In some implementations, the endorsement prompt module 156 may be allocated between the search server 114 and the client device 104. In some implementations, the functionality described herein as being performed by the endorsement prompt module 156 may be distributed among one or more of the search server 114, the endorsement server 112, the social network server 124 and the profile server 204. In some implementations, the endorsement prompt module 156 may be entirely operable as software on the client device 104.

Referring now to FIG. 3, an implementation for the endorsement prompt module 156 is shown. The endorsement prompt module 156 comprises a positive endorsement signal module 302, a negative endorsement signal module 304, a web history module 306, a search result module 308, a social data module 310 and combiner logic 312.

The positive endorsement signal module 302 and the negative endorsement signal module 304 are software and routines for retrieving information from the endorsement server 112 and providing it to the combiner logic 312. The positive endorsement signal module 302 retrieves positive endorsements related to the search results from the endorsement server 112. A positive endorsement is any signals direct, inferred, or implied that a user approves of, is interested in, likes, supports, endorses, or appreciates content, a search result or a web site or other displayed content. Similarly, the negative endorsement signal module 304 retrieves negative endorsements for the search results from the endorsement server 112. A negative endorsement is any signals direct, inferred, or implied that a user disapproves of, is not interested in, dislikes, does not support, endorse, or appreciate content, a search result or a web site or other displayed content. Both the positive endorsement signal module 302 and the negative endorsement signal module 304 have an output coupled to the combiner logic 312. The positive endorsement signal module 302 and negative endorsement signal module 304 provide these endorsements signals to the combiner logic 312, and the combiner logic 312 use the signals to determine whether a user should be prompted to endorse a search result. For example, if a search result has a negative endorsement by other users, the combiner logic 312 may not recommend a prompt be added to the search results. On the other hand, if the search result has a positive endorsement by other users, the combiner logic 312 may reduce a threshold applied before a prompt is presented thereby accelerating positive endorsements so that there is more of a gap between unendorsed results and positively endorse results. These are examples of how the positive and negative endorsement signals can be used in a number of other ways by the combiner logic 312 to determine how and when prompts are generated and presented to the user; other implementations are possible.

The web history module 306 is software, routines and storage for identifying the web history of the user. Although not shown, the web history module 306 may be coupled to the search engine 130, the web browser 202, or any other source that has information about the user's browsing history. The web history module 306 has an output coupled to the combiner logic 312. The web history module 306 provides information to the combiner logic 312 about the number of times a user has accessed a particular webpage or URL. In some implementations, the combiner logic 312 uses this information as an indication of the user's interest in a particular webpage and in response presents a prompt for endorsement. For example, if a user repeatedly goes to a particular webpage, then this web history information is provided by the web history module 306 to the combiner logic 312. In turn, the combiner logic 312 determines whether the number of times the user has visited this particular web page is above a predetermined threshold. If so, the combiner logic 312 may add an endorsement prompt to the search results. In some implementations, the combiner logic 312 may apply a time decay factor to some of the instances when the user accesses the webpage to modify whether a prompt will be generated. Other implementations, are possible. For example, in addition to a quantity of visits, a qualitative measure can also be used as a metric to determine whether to prompt a user for endorsement.

The search result module 308 is software and routines for receiving and processing search results from the ranking engine 152. In some implementations, the endorsement from module 156 is responsible for sending both the search results and the prompt back to the user. In some implementations this information may be filtered through the presentation engine 154. The search result module 308 is coupled to receive ranked search results from the ranking engine 152. The search results module 308 has an output coupled to the combiner logic 312 provides the ranked search results.

The social data module 310 is software and routines for retrieving social information from the social network server 124 and providing it to the combiner logic 312. The social data module 310 is coupled to query and receive information from the social network 124. The output of the social data module 310 is coupled to the combiner logic 312. For example, the social data module 310 may query the social network server 124 to determine whether any of the contacts of the user or other users in the social graph have reviewed similar search results. The social data module 310 may retrieve information from the social network server 124 using the identity of the user that submitted the search. The user's social graph, prior posts, photos, and other social information can be extracted by the social data module 310 and provided to the combiner logic 312 to aid in the determination of whether an endorsement prompt should be sent along with the search results.

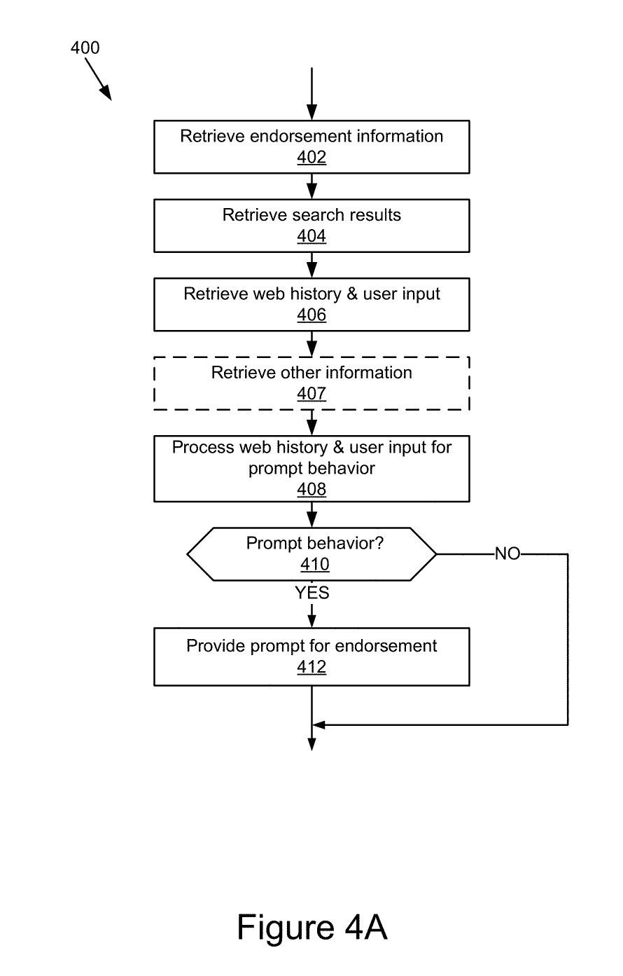

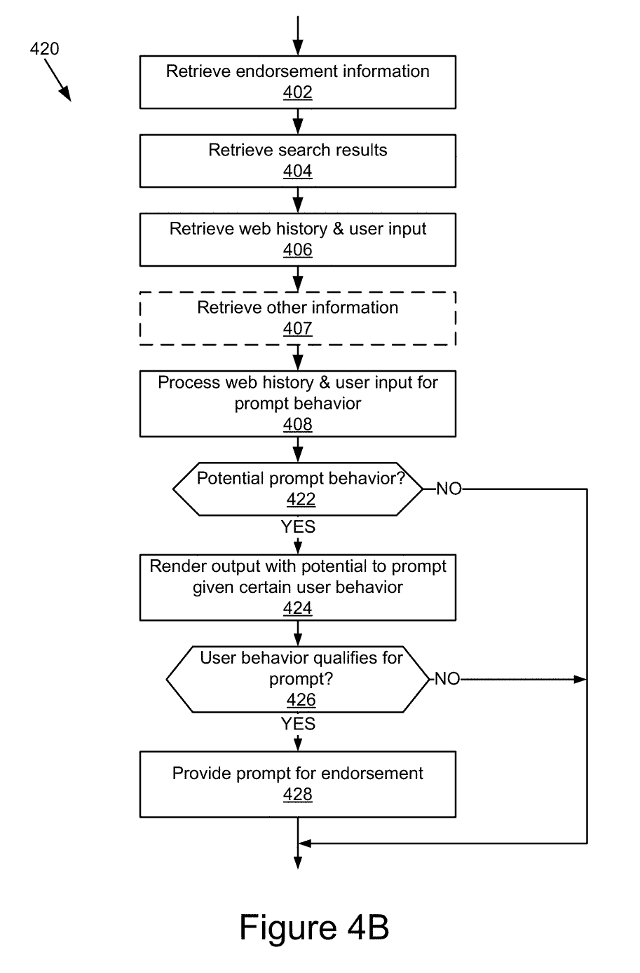

The combiner logic 312 is software and routines for determining whether to add an endorsement prompt to one or more of the search results. The combiner logic 312 is coupled to receive inputs from the positive endorsement signal module 302, the negative endorsement signal module 304, the web history module 306, the search results module 308 and the social data module 310. The combiner logic 312 analyzes the information received from these modules and determines whether an endorsement prompt should be added to the search results. Some implementations of the operation of the combiner logic 312 is described in more detail below with reference to FIG. 4A. For example, if the combiner logic 312 determines from the web history that a particular webpage or search result has been accessed by the user numerous times, the combiner logic 312 generates an endorsement prompt for that search result. Likewise, if the combiner logic 312 determines that a particular webpage is endorsed by some number of contacts of the user or other users in the social graph of the user, the combiner logic 312 generates an endorsement prompt for that webpage. The combiner logic 312 can use the positive endorsement signals, negative endorsement signals, the web history of the user, and social information about the user's social network, the user's interests, and other social information in any number of ways to determine whether to generate and present an endorsement prompt. In some implementations, as shown in FIG. 3, the combiner logic 312 outputs the search results and prompts 128B and sends them to the client device 104. In some implementations, the search results and prompt are provided to the presentation engine 154 which in turn provide the search results and prompts 128B to the client device.

The combiner logic 312 is also coupled to receive the input and movement of the input device, for example, cursor and keystrokes from the client device 104. In some implementations, the combiner logic 312 receives user input for example, cursor movement, keystrokes, transitions between web pages etc. In particular, if the user hovers over a search result, or transitions from one web page to another and then returns, or views a web pages for a predetermined amount of time before returning to a results page, or was presented with a prompt and did not endorse, presented with a prompt and did accept for a similar search result, and any other inputs by the user to the client device 104 or series of inputs to the client device 104.

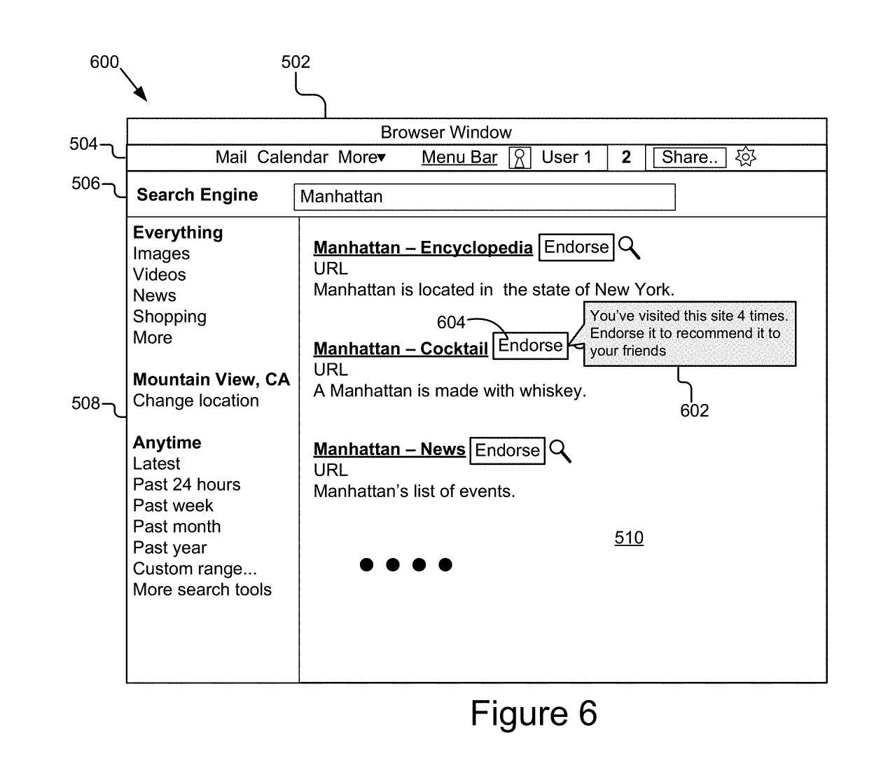

Referring now to FIG. 4A, one implementation of a method 400 for generating and sending endorsement prompts is described. The method 400 begins by retrieving 402 endorsement information. In some implementations, endorsement information includes whether a search result can be endorsed. In some implementations, endorsement information includes positive and negative endorsement signals from the endorsement server 112 retrieved by either the positive endorsement signal module 302 or the negative endorsement signal module 304. Endorsement information may also include any other information from the endorsement server 112. Next, the method 400 retrieves 404 search results. For example, the search results module 308 can retrieve search results from the ranking engine 152 as has been described above. Then the method 400 retrieves 406 the web history of the user and any user input. For example, the web history is obtained from the web history module 306 and the user input can be received directly from the client device 104. In an optional step, the method 400 retrieves 407 any additional information from any other sources. For example, the method 400 may retrieve social information using the social data module 310 from a social network server 124. The method may alternatively retrieve other types of public or authorized information , for example, preferences, interests, actions etc. from other sources , for example, profile servers, blogs, third-party sites, social networks or other sources. Using the information obtained in steps 402 to 407, the method processes 408 the web history and user input to determine whether there is prompt behavior. For example, if the user has clicked a particular search results more than a predetermined number of times that action may be identified as a prompt behavior in which the prompt should be presented. Another example is if the user selects a search result, views the selected search results for a predetermined amount of time and then returns to the search result page. If such actions by the user are found in step 408, it indicates a prompt behavior which a prompt should be presented to the user. Additionally, negative endorsement signals, for example, that the user has been presented an endorsement prompt but has decided not to endorse the result are other action that are considered a prompt behavior. Next, the method determines 410 whether a prompt behavior exists based on analysis in steps 408 of the retrieved information. If there is no prompt behavior the method is complete and ends. On the other hand, if there is a prompt behavior, the method 400 provides 412 a prompt endorsement for the result. The prompt in the result has been sent to the client device for display to the user. Examples of prompts being displayed are shown in FIGS. 6-9 below.

Referring now to FIG. 4B, another implementation of a method 420 for generating and sending endorsement prompts is described. The method 420 begins by retrieving 402 endorsement information. The method continues to perform steps 402 to 408 as has been described above. Steps 402 to 408 have the same or similar functionality as has been described above with reference to FIG. 4A so that description will not be repeated here. The method 420 continues by determining 422 whether there is potential prompt behavior. “Potential” prompt behavior includes any number of behaviors or interactions by the user that may lead to the presentation of a prompt. For example, a back button click is a potential prompt behavior. If the user performs a search and search results are displayed to the user, the user clicks or selects a result from the search, then the user clicks or selects a back button after some minimum visit duration, the method 420 presents a prompt. A second example of a potential prompt behavior is detecting when a first time user of the endorsement server 112 identifies a promo for some results which have a social endorsement. A third example of a potential prompt behavior is if the user has shared or endorsed a URL in some social network publicly (where the user has linked his/her identity on that network with the users in the profile server 204). A fourth example of a potential prompt behavior is if the user has shared or endorsed a URL in some private space like email or a private share on a social network and the profile server 204 has been granted access to this data by the user. A fifth example of a potential prompt behavior if the user has shared with the profile server 204 that he/she has viewed the URL (through a reader program, or clicks on links in emails received by the user, etc.). If it is determined in step 422 that there is no a potential prompt behavior, the method ends. However, if it is determined in step 422 that there is potential prompt behavior, the method 420 continues by rendering 424 output with the potential to prompt given certain user behavior. For example, the method 420 may generate a prompt in response to a back button click from a result. Then the method 420 receives user input and determines 426 whether the user behavior qualifies for an endorsement prompt. If not, the method ends. On the other hand, if the user behavior does qualify for endorsement prompt, the method 420 provides 428 a prompt for endorsement and ends.

Referring now to FIGS. 5-9, some implementations for presenting search results, in particular with endorsement prompts are shown.

FIG. 5 illustrates one implementation of a user interface 500 in which search results are shown in a browser window 502. In this example, three search results are returned in response to a query for the term “Manhattan.” In this example, numerous search results are returned in response to a query for the term “Manhattan” and the top three search results are shown. The user interface 500 includes a browser window 502 having a number of components including a top label, a menu bar 504, a bar 506 for a search engine and input box, a side/location bar 508, and a display area 510. The menu bar 504 provides menus to access browser functionality. In some implementations, the browser window 502 could include content from a publisher page that includes at least one endorsement button similar to the button shown in FIGS. 4-6. A search result 512 can include a heading 514 (e.g., a link to a resource), an endorsement button 516, a search button 518, a URL 520 and a snippet 522. While the present technology will be described below in the context of the endorsement button 516, the endorsement button 516 could be an action to share the content or even be a suggestion to use a share button (not shown) to share content.

FIG. 6 illustrates a first implementation of the user interface 600 showing an endorsement prompt 602 in a browser window 502. In this user interface 600, the same three search results as shown above in FIG. 5 are presented. However, the user interface 600 also displays the endorsement prompt 602 associated with and positioned proximate the endorsement button 604. The user interface 600 is presented in response to an indication of the user's interest (e.g., a quantitative or qualitative indicator of interest) in the second search result and when the user receives the second search result again either when returning to the results page of FIG. 5 or if the second search result is part of a different results page. The endorsement prompt 602 may also be presented if the user has reviewed the second search result and then selects the back button to return to the search result page. In this implementation, endorsement prompt 602 is a box that provides additional information to the user as to why he/she is being prompted to endorse the search result. In this example, the endorsement prompt 602 box indicates that the user has visited this site four times and indicates a reason why the user may want to select the endorsement button 604. The message contained in the endorsement prompt 602 can be customized based upon the information used to generate the endorsement prompt 602. The user interface shown in FIG. 6, is merely one example and various other callouts may be used and associated with different results and with different messages from that shown in the browser window 502.

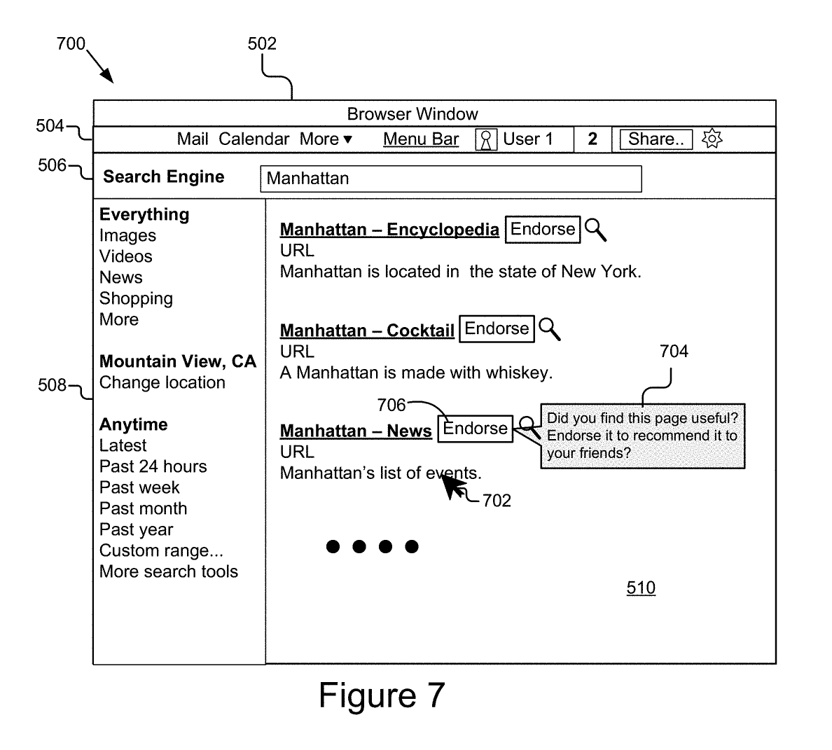

FIG. 7 illustrates a second implementation of the user interface 700 showing an endorsement prompt 704 in a browser window 502. Again, in this user interface 700, the same three search results as shown above in FIG. 5 are presented. FIG. 7 also shows a cursor 702 indicating the position of the input device of the user 102. In response to a hover over input by the user 102, the user interface 700 is updated to display the endorsement prompt 704. In some implementations, the endorsement prompt 704 is presented when the user 102 hovers over the search result. In some implementations, the endorsement prompt 704 is only presented when the user hovers over the endorsement button 706 associated with the search result. This endorsement prompt 704 can be presented in response to the hover over plus a previous indication of user interest or just upon hover based on analysis of other behaviors as described above with reference to FIG. 3. In some implementations, the endorsement prompt 704 is a box including text with a question for the user and a reason to select the endorsement button 706. Other message and information can be provided in the endorsement prompt 704 to influence the user, educate the user, inform the user or otherwise get the user to accept or reject the endorsement.

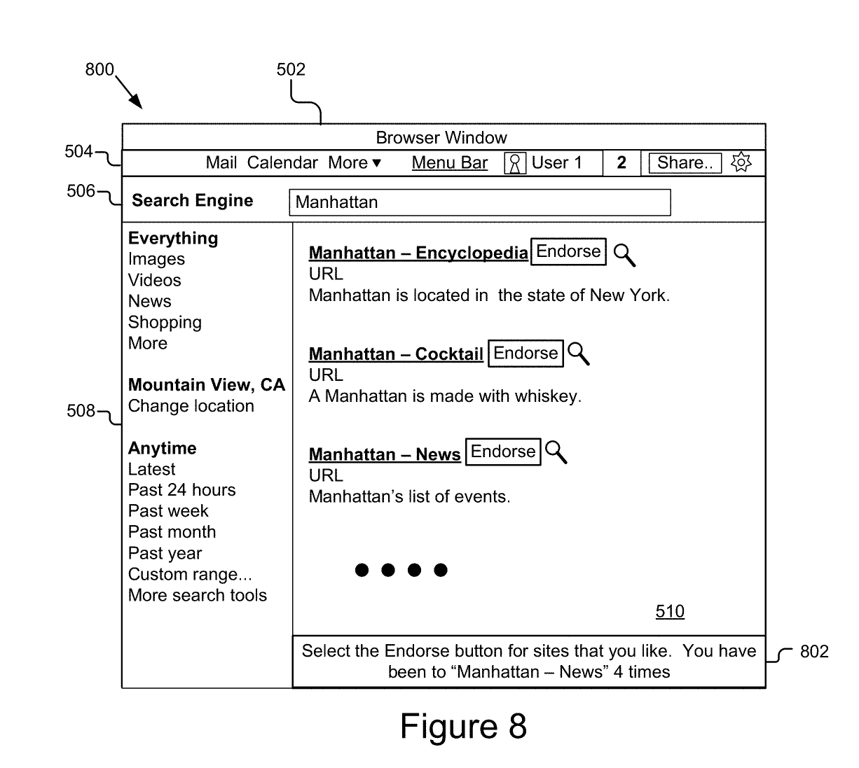

FIG. 8 illustrates a third implementation of the user interface 800 showing an endorsement prompt 802 in the browser window 502. Again, in this user interface 800, the same three search results as shown above in FIG. 5 are presented. FIG. 8 shows an implementation for the endorsement prompt 802 that can be used in cases where less information is known about the user and a more generic prompt is being presented to the user. For example, this may be used to suggest to the user that he/she use the endorsement system. The endorsement prompt 802 is a box proximate the bottom of the display area 510. In this case, endorsement prompt 802 indicates a search result and the number of times the user has visited that site. Other influencing factor as to why the prompt is being presented can also be indicated in the implementation of the endorsement prompt 802.

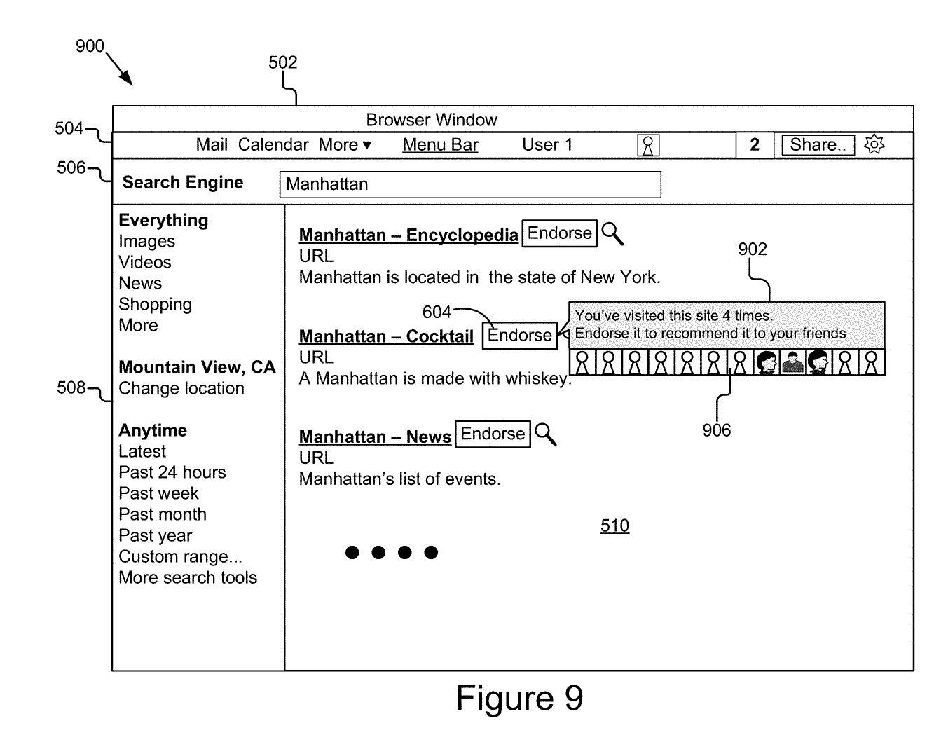

FIG. 9 illustrates a fourth implementation of the user interface 900 showing an endorsement prompt 902 in the browser window 502. Again, in this user interface 900, the same three search results as shown above in FIG. 5 are presented. FIG. 9 shows an implementation for the endorsement prompt 902 similar to that described above with reference to FIG. 6. The endorsement prompt 902 is positioned proximate the endorsement button 604 of a search result. The endorsement prompt 902 also includes information for the user about the prompt, why it is being presented, what the impact of endorsing is, etc. However in this case, the endorsement prompt 902 is a box having a first text area 904 and a second area 906. The first text area 904 is like that described above and includes information for the user about why the prompt is being presented and other information about endorsements and their effects. In this implementation, the endorsement prompt module 156 also communicates with the social network server 124 to retrieve information about the user, and the endorsement server 112 to determine other users that have endorsed the search result. This information is used by the endorsement prompt module 156 to retrieve photos of other users that have endorsed the result. In some implementations, the second area 906 includes one or more photos of other users that have already endorsed the result. In another implementation, the second area 906 includes one or more photos of users that are both in the user's social graph and have endorsed the result. Various other ways that the second area 906 may be populated with photos, user names or other information to get the user to endorse the result.

An automated endorsement prompt system has been described is described. In the above description, for purposes of explanation, numerous specific details were set forth. It will be apparent, however, that the disclosed technologies can be practiced without these specific details. In other instances, structures and devices are shown in block diagram form. For example, the disclosed technologies are described in one implementation below with reference to user interfaces and particular hardware. Moreover, the technologies disclosed above primarily in the context of a social network; however, the disclosed technologies apply to other data sources and other data types (e.g., collections of other resources for example, images, audio, web pages) that can be used to refine the search process.

Reference in the specification to “one implementation,” “an implementation” or “this implementation” means that a particular feature, structure, or characteristic described in connection with the implementation is included in at least one implementation of the disclosed technologies. The appearances of the phrase “in one implementation” in various places in the specification are not necessarily all referring to the same implementation.

Some portions of the detailed descriptions above were presented in terms of processes and symbolic representations of operations on data bits within a computer memory. A process can generally be considered a self consistent sequence of steps leading to a result. The steps may involve physical manipulations of physical quantities. These quantities take the form of electrical or magnetic signals capable of being stored, transferred, combined, compared, and otherwise manipulated. These signals may be referred to as being in the form of bits, values, elements, symbols, characters, terms, numbers or the like.

These and similar terms can be associated with the appropriate physical quantities and can be considered labels applied to these quantities. Unless specifically stated otherwise as apparent from the prior discussion, it is appreciated that throughout the description, discussions utilizing terms such as “processing” or “computing” or “calculating” or “determining” or “displaying” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The disclosed technologies may also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, for example, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The disclosed technologies can take the form of an entirely hardware implementation, an entirely software implementation or an implementation containing both hardware and software elements. In one implementation, the technology is implemented in software, which includes but is not limited to firmware, resident software, microcode, etc.

Furthermore, the disclosed technologies can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

Finally, the processes and displays presented herein may not be inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the disclosed technologies were not described with reference to any particular programming language. It will be appreciated that a variety of programming languages may be used to implement the teachings of the technologies as described herein.

The foregoing description of the implementations of the present techniques and technologies has been presented for the purposes of illustration and description. It is not intended to be exhaustive or to limit the present techniques and technologies to the precise form disclosed. Many modifications and variations are possible in light of the above description. It is intended that the scope of the present techniques and technologies be limited not by this detailed description. The present techniques and technologies may be implemented in other specific forms without departing from the spirit or essential characteristics thereof. Likewise, the particular naming and division of the modules, routines, features, attributes, methodologies and other aspects are not mandatory or significant, and the mechanisms that implement the present techniques and technologies or its features may have different names, divisions and/or formats. Furthermore, the modules, routines, features, attributes, methodologies and other aspects of the present disclosure can be implemented as software, hardware, firmware or any combination of the three. Also, wherever a component, an example of which is a module, is implemented as software, the component can be implemented as a standalone program, as part of a larger program, as a plurality of separate programs, as a statically or dynamically linked library, as a kernel loadable module, as a device driver, or in other ways. Additionally, the present techniques and technologies are not limited to implementation in any specific programming language, or for a specific operating system or environment. Accordingly, the disclosure of the present techniques and technologies is intended to be illustrative, but not limiting.

1. A computer-implemented method performed by a system of one or more computers, the method comprising:
receiving, by the system, a query from a user;
obtaining, by the system, a first search result and a second search result based on the query, the first search result representing a first resource and the second search result representing a second resource;
obtaining, by the system, additional information about user interactions of the user with the first resource and the second resource;
determining, for each resource, and by combiner logic of the system, whether the user interactions with the resource meet a predetermined user interaction threshold;
determining, by combiner logic of the system, that the user interactions with the first resource meet the predetermined user interaction threshold and that the user interactions with the second resource do not meet the predetermined user interaction threshold;
generating, by the system, a first endorsement prompt prompting the user to endorse the first resource and no endorsement prompt prompting the user to endorse the second resource in response to determining that the user interactions with the first resource meet the predetermined user interaction threshold and the user interactions with the second resource fail to meet the predetermined user interaction threshold; and
transmitting, by the system, a response to the query, the response including a first interactive endorsement element for display adjacent to the first search result and a second interactive endorsement element for display adjacent to the second search result, each interactive endorsement element operable to be selected by the user to endorse the resource represented by the respective search result, the response further including the first endorsement prompt for display adjacent to the first interactive endorsement element and including no endorsement prompt prompting the user to endorse the second resource.

2. The method of claim 1 wherein the additional information includes a positive endorsement signal, a negative endorsement signal, a web history, user interactions with a search result, or social data for the user.

3. The method of claim 1 wherein the additional information includes a received user input signal from a client device.

4. The method of claim 3 wherein the received user input signal from the client device indicates a transition from a search result page to a first web page and a return to the search result page after a predetermined amount of time.

5. The method of claim 2 wherein the additional information includes a positive endorsement signal for the first search result.

6. The method of claim 1 wherein the additional information includes a signal indicating that an endorsement prompt was presented to the user and rejected by the user.

7. The method of claim 2 wherein the additional information includes user interactions with the first search result and indicates that the user has interacted with the first search result a predetermined number of times.

8. The method of claim 2 wherein the additional information includes the web history indicating that the user has viewed a web page a predetermined number of times.

9. The method of claim 2 wherein the additional information includes social data that indicates that the first resource was endorsed by a specific number of the user's contacts from a social network.

10. The method of claim 2 wherein the additional information includes a negative endorsement signal for the second search result.

11. The method of claim 1 wherein the first endorsement prompt includes an explanation about why the endorsement prompt is being presented.

12. The method of claim 1 wherein the first endorsement prompt includes one or more identifiers of other users that have endorsed the resource.

13. A computer program product comprising a non-transitory computer readable medium storing a computer readable program, wherein the computer readable program, when executed on a computer, causes the computer to perform operations comprising:
receiving a query from a user;
obtaining a first search result and a second search result based on the query, the first search result representing a first resource and the second search result representing a second resource;
obtaining additional information about user interactions of the user with the first resource and the second resource;
determining, for each resource, and by combiner logic, whether the user interactions with the resource meet a predetermined user interaction threshold;
determining, by the combiner logic, that the user interactions with the first resource meet the predetermined user interaction threshold and that the user interactions with the second resource do not meet the predetermined user interaction threshold;
generating a first endorsement prompt prompting the user to endorse the first resource, and no endorsement prompt prompting the user to endorse the second resource in response to determining that the user interactions with the first resource meet the predetermined user interaction threshold and the user interactions with the second resource fail to meet the predetermined user interaction threshold; and
transmitting a response to the query, the response including a first interactive endorsement element for display adjacent to the first search result and a second interactive endorsement element for display adjacent to the second search result, each interactive endorsement element operable to be selected by the user to endorse the resource represented by the respective search result, the response further including the first endorsement prompt for display adjacent to the first interactive endorsement element and including no endorsement prompt prompting the user to endorse the second resource.

14. The computer program product of claim 13, wherein the additional information includes a positive endorsement signal, a negative endorsement signal, a web history, user interactions with a search result, or social data for the user.

15. The computer program product of claim 13, wherein the additional information includes a received user input signal from a client device.

16. The computer program product of claim 15, wherein the received user input signal from the client device indicates a transition from a search result page to a first web page and a return to the search result page after a predetermined amount of time.

17. The computer program product of claim 14, wherein the additional information includes a positive endorsement signal for the first search result.

18. The computer program product of claim 13, wherein the additional information includes a signal indicating that an endorsement prompt was presented to the user and rejected by the user.

19. The computer program product of claim 13, wherein the additional information includes user interactions with the first search result and indicates that the user has interacted with the first search result a predetermined number of times.

20. The computer program product of claim 14, wherein the additional information includes the web history indicating that the user has viewed a web page a predetermined number of times.

21. The computer program product of claim 14, wherein the additional information includes social data that indicates that the first resource was endorsed by a specific number of the user's contacts from a social network.

22. The computer program product of claim 14, wherein the additional information includes a negative endorsement signal for the second search result.

23. The computer program product of claim 13, wherein the first endorsement prompt includes an explanation about why the prompt is being presented.

24. The computer program product of claim 13, wherein the first endorsement prompt includes one or more identifiers of other users who have endorsed the resource.

25. A system comprising:
a processor, and;
a memory storing instructions that, when executed, cause the processor of the system to perform operations comprising:
receiving, by the system, a query from a user;
obtaining, by the system, a first search result and a second search result based on the query, the first search result representing a first resource and the second search result representing a second resource;
obtaining, by the system, additional information about user interactions of the user with the first resource and the second resource;
determining, for each resource, and by combiner logic of the system, whether the user interactions with the resource meet a predetermined user interaction threshold;
determining, by the combiner logic of the system, that the user interactions with the first resource meet the predetermined user interaction threshold and that the user interactions with the second resource do not meet the predetermined user interaction threshold;
generating, by the system, a first endorsement prompt prompting the user to endorse the first resource and no endorsement prompt prompting the user to endorse the second resource in response to determining that the user interactions with the first resource meet the predetermined user interaction threshold and the user interactions with the second resource fail to meet the predetermined user interaction threshold; and
transmitting, by the system, a response to the query, the response including a first interactive endorsement element for display adjacent to the first search result and a second interactive endorsement element for display adjacent to the second search result, each interactive endorsement element operable to be selected by the user to endorse the resource represented by the respective search result, the response further including the first endorsement prompt for display adjacent to the first interactive endorsement element and including no endorsement prompt prompting the user to endorse the second resource.

26. The system of claim 25, wherein the additionally information includes a positive endorsement signal, a negative endorsement signal, a web history, user interactions with a search result, or social data for the user.

27. The system of claim 25, wherein the additional information includes a received user input signal from a client device.

28. The system of claim 27, wherein the received user input signal from the client device indicates a transition from a search result page to a first web page and a return to the search result page after a predetermined amount of time.

29. The system of claim 26, wherein the additional information includes a positive endorsement signal for the first search result.

30. The system of claim 25, wherein the additional information includes a signal indicating that an endorsement prompt was presented to the user and rejected by the user.

31. The system of claim 26, wherein the additional information includes user interactions with the first search result and indicates that the user has interacted with the first search result a predetermined number of times.

32. The system of claim 26, wherein the additional information includes the web history indicating that the user has viewed a web page a predetermined number of times.

33. The system of claim 26, wherein the additional information includes social data that indicates that the first resource was endorsed by a specific number of the user's contacts from a social network.

34. The system of claim 26, wherein the additional information includes a negative endorsement signal for the second search result.

35. The system of claim 25, wherein the first endorsement prompt includes an explanation about why the endorsement prompt is being presented.

36. The system of claim 25, wherein the first endorsement prompt includes one or more identifiers of other users that have endorsed the resource.
